(19) United States
(12) Patent Application Publication
(10) Pub. No.: US 2014/0003775 A1
(43) Pub. Date: Jan. 2, 2014

(54) FIBER OPTIC CABLE

(71) Applicants: Jamyuen KO, Santa Clara, CA (US); Qi QI, San Jose, CA (US)

(72) Inventors: Jamyuen KO, Santa Clara, CA (US); Qi QI, San Jose, CA (US)

(21) Appl. No.: 13/536,249

(22) Filed: Jun. 28, 2012

(51) Int. Cl. G02B 6/44; G02B 6/04

(52) U.S. Cl. 385/101; 385/114

(57) ABSTRACT

According to various embodiments, a cable includes a ribbon fiber having multiple optical fibers joined together and disposed within a conduit extending along a length of the cable, the conduit has an inner diameter sufficiently larger than a largest cross-sectional length of the ribbon fiber to enable the ribbon fiber to rotate freely.

### FIELD

This disclosure relates generally to optical fiber cables, and more particularly, to optical fiber cables having improved bending performance characteristics.

### BACKGROUND

Optical fibers are used widely for connecting devices both locally and over long distances. While the bandwidth for data for single optical fibers is large compared to copper wiring, some applications nonetheless call for multiple optical fibers. One approach to the use of multiple fibers is to combine several fibers within one cable in a ribbon form. Such ribbon cables find application, for example, in Local Area Networks (LANs), allowing the data capacity of several fibers to be provided with a single cable-pull and a single connection. Use of ribbon cables allows for improved use of space for cable runs, particularly for areas in which space is at a premium due to system density, such as data centers. Compared to traditional cables, ribbon cables may provide nearly 50 percent space savings.

During installation, care is taken to ensure that the routing of optical fiber cables avoids excessive bending that may lead to breakage. However, bending at a radius less than that sufficient to cause breakage can, nonetheless, lead to problems with optical cables. Bending can lead, for example, to signal strength loss where light carried by the fiber is incident on the core-cladding interface at an angle greater than the acceptance angle of the fiber. Likewise, adjacent fibers within a common cable that is bent, can tend to experience increased issues with cross-talk.

### BRIEF DESCRIPTION OF THE DRAWINGS

FIG. 1 is a cutaway view of a cable in accordance with an embodiment;

FIG. 2 is an end view of a cable in accordance with an embodiment;

FIG. 3 is an end view of a face of a cable in accordance with an embodiment;

FIG. 4 is an end view of a face of a cable in accordance with an embodiment;

FIG. 5 is an end view of a face of a cable in accordance with an embodiment;

FIG. 6 is an end view of a face of a cable in accordance with an embodiment;

FIG. 7 is an end view of a face of a cable in accordance with an embodiment;

FIG. 8 is an end view of a face of a cable in accordance with an embodiment;

FIG. 9 illustrates an embodiment of an optical cable assembly in accordance with an embodiment;

FIG. 10 illustrates an embodiment of an optical cable assembly in accordance with an embodiment; and

FIG. 11 illustrates an embodiment of an optical cable assembly in accordance with an embodiment.

### DETAILED DESCRIPTION

In the description that follows, to illustrate one or more aspect(s) of the present disclosure in a clear and concise manner, the drawings may not necessarily be to scale and certain features may be shown in somewhat schematic form. Features that are described and/or illustrated with respect to one aspect may be used in the same way or in a similar way in one or more other aspects and/or in combination with or instead of the features of the other aspects of the technology disclosed herein.

In accordance with various embodiments of the present disclosure, a cable includes a ribbon fiber having multiple optical fibers joined together and disposed within a conduit extending along a length of the cable, the conduit has an inner diameter sufficiently larger than a largest cross-sectional length of the ribbon fiber to enable the ribbon fiber to rotate freely.

These and other features and characteristics, as well as the methods of operation and functions of the related elements of structure and the combination of parts and economies of manufacture, will become more apparent upon consideration of the following description and the appended claims with reference to the accompanying drawings, all of which form a part of this specification. It is to be expressly understood, however, that the drawings are for the purpose of illustration and description only and are not intended as a definition of the limits of claims. As used in the specification and in the claims, the singular form of “a”, “an”, and “the” include plural referents unless the context clearly dictates otherwise.

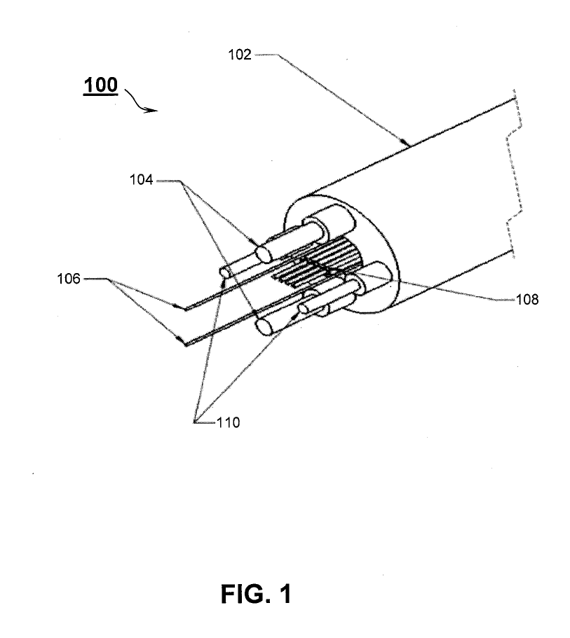

Turning now to the various aspects of the disclosure, FIG. 1 depicts a cable (generally indicated at 100) in accordance with an embodiment. The cable 100 includes a jacket 102 that may be, for example, PVC. Typically, the jacket 102 will be made from a material chosen to offer a degree of mechanical and chemical protection to the internal cable components. In an embodiment, the jacket 102 has an outer diameter of about 3.5 mm, though it will be appreciated that this measurement will vary dependent on the particular configuration and contemplated end use.

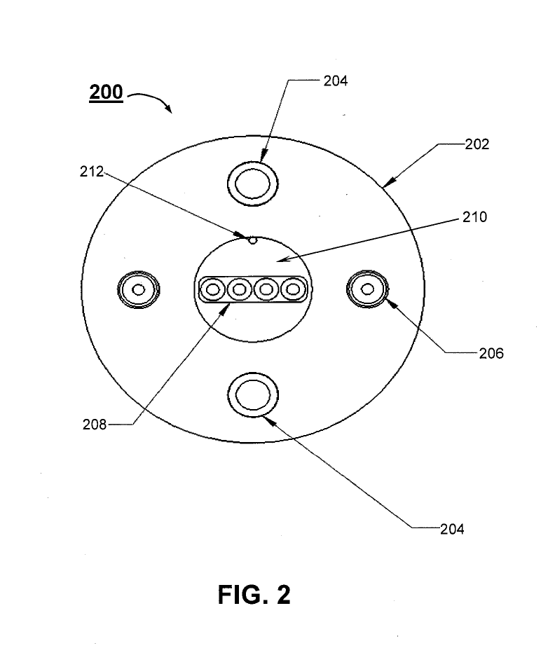

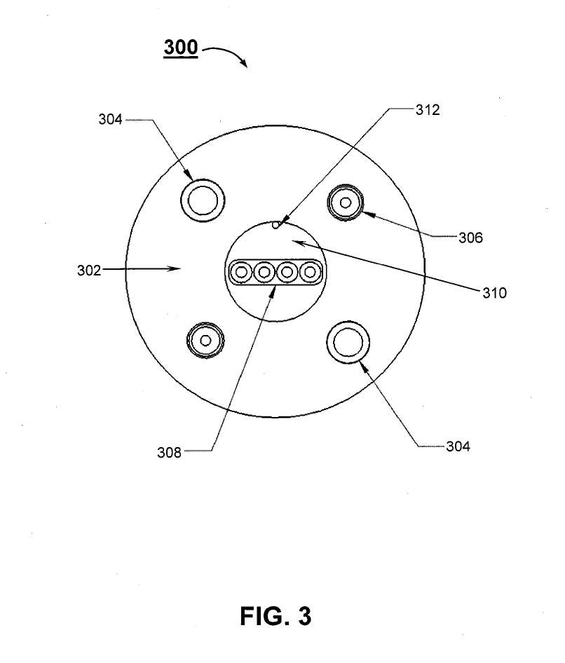

In the embodiment of FIG. 1, insulated copper wires 104 are included in cable 100 which may be used for a variety of applications, such as, for example, power transmission. Additionally, strength members 106 provide tensile strength to cable 100, allowing installers to safely pull cable 100 through channels without damaging the transmission components. The strength members 106 may be, for example, Kevlar®, available from DuPont, though it will be appreciated that various other materials with adequate tensile strength may be used. As will be appreciated, though two strength members 106 are illustrated, one or more strength members may be used (as in the embodiments of FIGS. 2 and 3, for example), and a design without any strength members would remain consistent with principles of the present concept.

In the illustrated embodiment, a ribbon fiber 108 runs along the interior of the cable 100. The ribbon fiber 108 includes several optical fibers arrayed along a line extending approximately along a diameter of a central opening (not visible in this view) in the jacket 102 of the cable 100. Each fiber may be a single or multimode optical fiber having a core configured and arranged to transmit optical signals and a cladding configured and arranged to internally reflect the optical signal such that it is transmitted substantially within the core. In the embodiment of FIG. 1, a second set of insulated copper wires 112 is provided as ground for the power wires 104. As will be appreciated, the two sets of copper wires 104, 112 form two power/ground pairs, though a single ground could, in principle, provide grounding for both power wires. Likewise, any of the copper wires 104, 112 may, in principle, be used to provide data signals rather than power/ground functionality.

FIG. 2 is an end view of cable 200 in accordance with an embodiment. A jacket 202 includes insulated wires 204 and coaxial cables 206. These wires may transmit signals, power, ground or provide other electrical functionality. As can be seen from this view, ribbon fiber 208 is positioned within conduit 210 formed in jacket 202. The conduit 210 has an inner diameter that is selected such that it is large enough to accommodate rotation of ribbon fiber 208 within conduit 210. That is, the inner diameter is larger than a largest cross sectional length of the ribbon fiber. For a fiber having major and minor axes (i.e., the fiber is larger in one cross sectional dimension than in another, perpendicular dimension, e.g., wider than it is tall), the inner diameter should be larger than the major axis. Furthermore, the inner diameter should be larger than a diagonal of a cross section of the ribbon fiber. For the case where the ribbon fiber has rounded corners (as in the illustrated embodiments) the “diagonal” may not be a true diagonal, as there are no corners, but the scope of the concept should be understood to encompass this and other particular shapes. By way of example, this may mean that the conduit 210 has a diameter that is between 105% and 150% of the largest cross sectional length (in the simplest case, the diagonal) of the ribbon fiber 208.

Strength member 212 is included to provide pull strength and may be Kevlar® as noted above. When cable 200 is compressed, bent or pinched by an external force applied to the jacket 202, ribbon fiber 208 is free to move and rotate within the conduit and can move and rotate in such a way that a flat side of the ribbon cable 208 tends to position itself normal to the external force. Because force is applied normal to the ribbon cable, instead of along its width, there is relatively little force pressing the fibers against each other, reducing the probability of fiber crossing, which tends to be a source of optical loss.

FIG. 3 illustrates an embodiment of cable 300 in which the relative orientation of ribbon fiber 308 and other components, such as insulated wires 304 and coaxial cables 306, are rotated relative to the embodiment shown in FIG. 2. Jacket 302 and strength member 312 may be similar to the jackets and strength members of other illustrated embodiments. As will be appreciated, the illustrated orientation represents the stress-free orientation of components. As described above, as cable 300 is bent, ribbon fiber 308 will tend to re-orient itself within the conduit 310, changing the relative orientation.

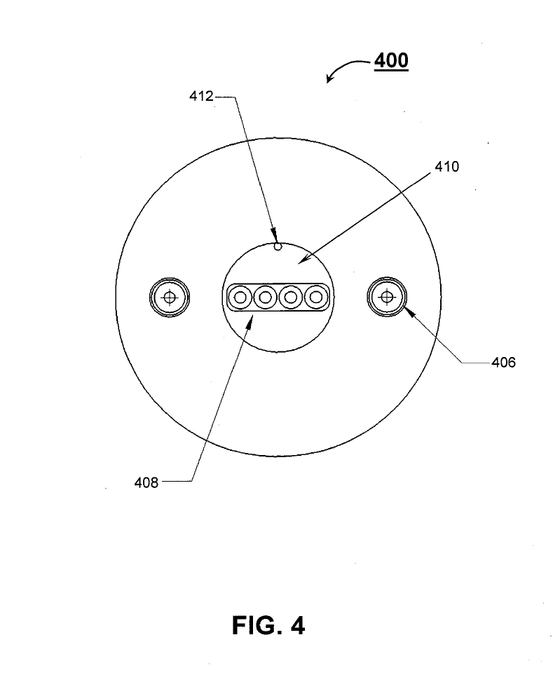

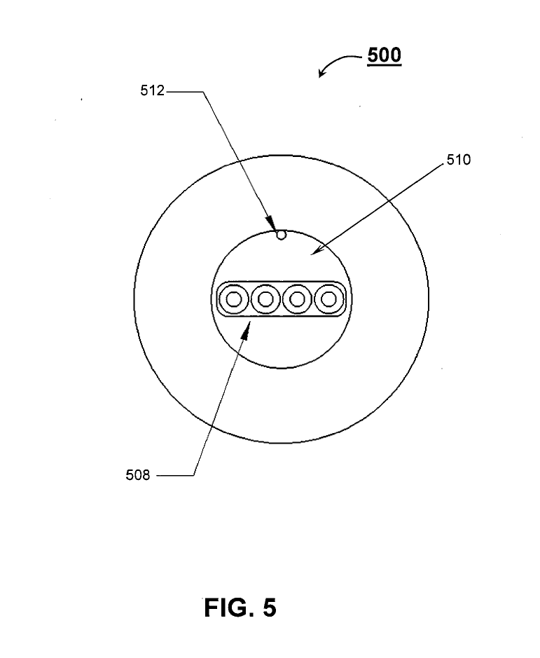

FIG. 4 illustrates an embodiment of cable 400 in which only a pair of coaxial cables 406 and a ribbon fiber 408 positioned within conduit 410 are included, along with an optional strength member 412. FIG. 5 presents an even more sparing embodiment of a cable 500 having only the ribbon fiber 508 positioned within conduit 510 and a single optional strength member 512.

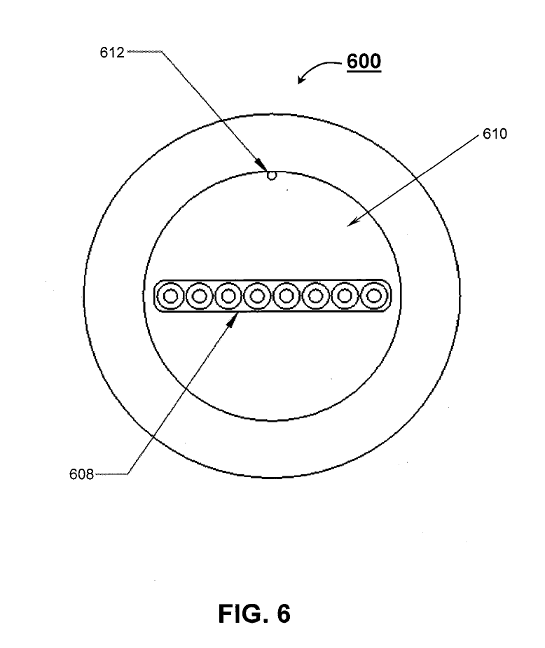

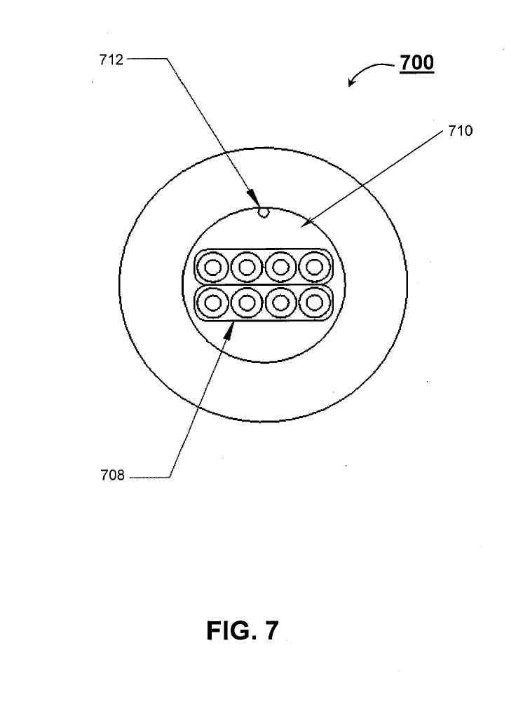

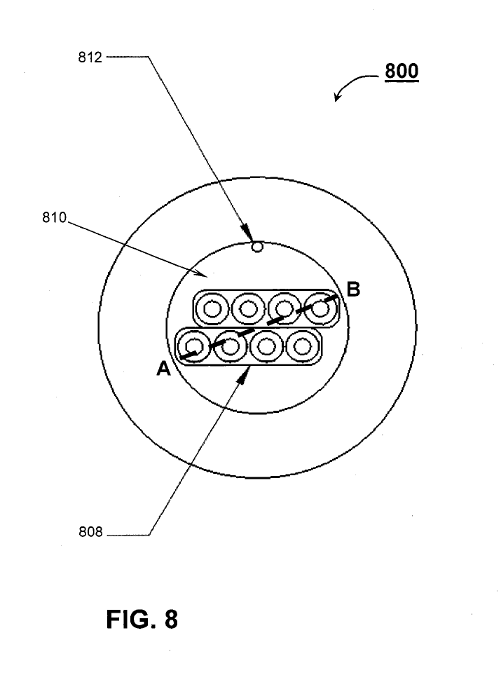

FIG. 5 illustrates an embodiment of cable 500 that lacks electrical conductors. A ribbon fiber 508 is positioned within conduit 510 along with strength member 512. FIG. 6 illustrates an embodiment in which cable 600 includes a 1×8 ribbon fiber 608 in the conduit along with strength member 612. FIG. 7 illustrates an embodiment of cable 700 that also lacks electrical conductors. Ribbon fiber 708 includes two stacked 1×4 ribbons (or alternately, a single 2×4 ribbon) is positioned in the conduit with strength member 712. FIG. 8 illustrates an embodiment of cable 800 likewise without electrical conductors. Ribbon fiber 808 includes staggered or offset 1×4 ribbons and strength member 812 is also held within the conduit 810. For the offset ribbons, the largest cross sectional length will run from approximately point A to approximately point B.

Though the ribbon fibers 108, 208, 308, 408, 508, 608, 708, 808 are shown variously as 1×4 or 1×8 ribbons, it will be appreciated that the principles of the concept are applicable to ribbons of various configurations. Various types of terminations or connectors may be used, including, for example, MTP or MPO connectors for fiber connections. Likewise, for embodiments having both optical and electrical transmission elements, custom connectors or otherwise adapted connectors may be used.

Cables in accordance with embodiments may include aramid yarn, buffer tubing, Kevlar protective layers or the like. For environments in which mechanical attack is likely, steel or copper armor layers and/or helical strength members may also optionally be included. For water resistance, solid barriers in addition to the jacket 102 (for example copper tubes), water-repellent gels or water-absorbing powders may be provided around the fiber.

Cables in accordance with the embodiments presented herein may optionally include electrical wiring for power as described above and may run over distances of tens of meters. For such cables, termination devices, components, connectors, plugs, etc. may include optical to electrical conversion functionality, or may be configured to terminate at a device incorporating the appropriate conversion optoelectronics. As such, various communication protocols or standards may be used for embodiments described herein. As will be appreciated, embodiments may include connectors at either or both ends of the cable, and each end may have a different or the same type of connector and/or be configured for use with a different or the same protocol.

For example, embodiments may find application in cables in accordance with the Thunderbolt active cable interface concept incorporating transmission capabilities according to both PCI Express and DisplayPort protocols. Applicable protocols may include, but are not limited to, mini DisplayPort, standard DisplayPort, mini universal serial bus (USB), standard USB, PCI express (PCIe), Ethernet, high-definition multimedia interface (HDMI), etc. It will be appreciated that each standard may include a different configuration or pinout for the electrical contact assembly. Additionally, the size, shape and configuration of the connector may be dependent on the standard, including tolerances for the mating of the corresponding connectors. Thus, the layout of the connector to integrate the optical I/O assembly may be different for the various standards.

Moreover, as will be understood by those of skill in the art, optical interfaces make use of line-of-sight connections to have an optical signal transmitter interface with a receiver (both may be referred to as lenses). Thus, the configuration of the connector will be such that the lenses are not obstructed by the corresponding electrical contact assemblies if present. For example, optical interface lenses can be positioned to the sides of the contact assemblies, or above or below, depending on where space is available within the connector.

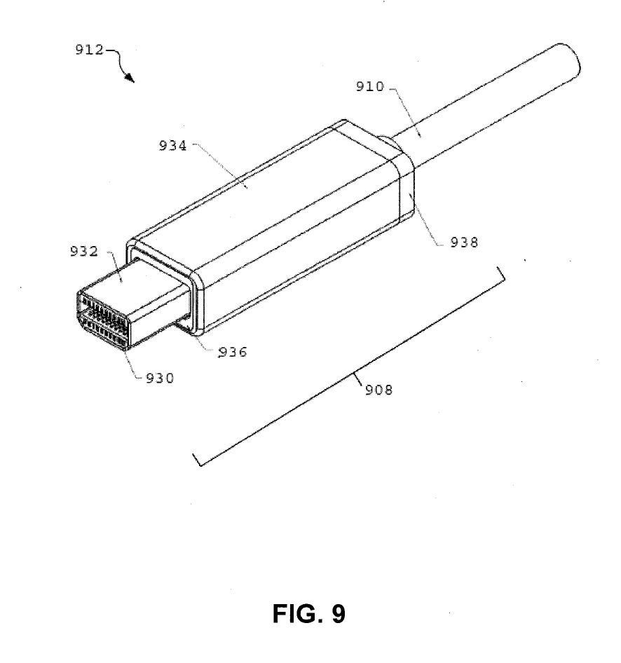

FIG. 9 illustrates an embodiment of an optical cable assembly 912 for use with cable 910 that is configured in accordance with one of the embodiments describe above. As shown in FIG. 9, the optical cable assembly 912 includes a connector plug 908 coupled to cable 910. The connector plug 908 may include a light engine incorporated into the connector plug 908 for providing an optical interface. That is, the light engine is a module that includes those components used for converting optical signals to electrical and vice versa. While the specific example illustrated is a mini DisplayPort (mDP) connector, it will be understood that other connector types can be equally constructed as described herein. Thus, optical communication through a standard connector can be implemented in an active way by fitting optical circuitry and optical components, or electro-optical circuitry and components, into the connector plug 908 as illustrated in the optical cable assembly 912.

The connector plug 908 may include a plug housing 930 and a metal housing 932. The metal housing 932 may be configured to provide mechanical interfacing and to ground the connector plug 908. More particularly, metal housing 932 may be configured to provide positional rigidity for the plug housing 930, and electromagnetic shielding when the connector plug 908 is mated with a corresponding plug. The plug housing 930 may be configured to provide additional mechanical interfacing structure and a structure or mechanical framework in which to incorporate the I/O interfaces. The connector plug 908 may further include a boot 934, a boot cover 936, and an end 938 coupled with the boot 934.

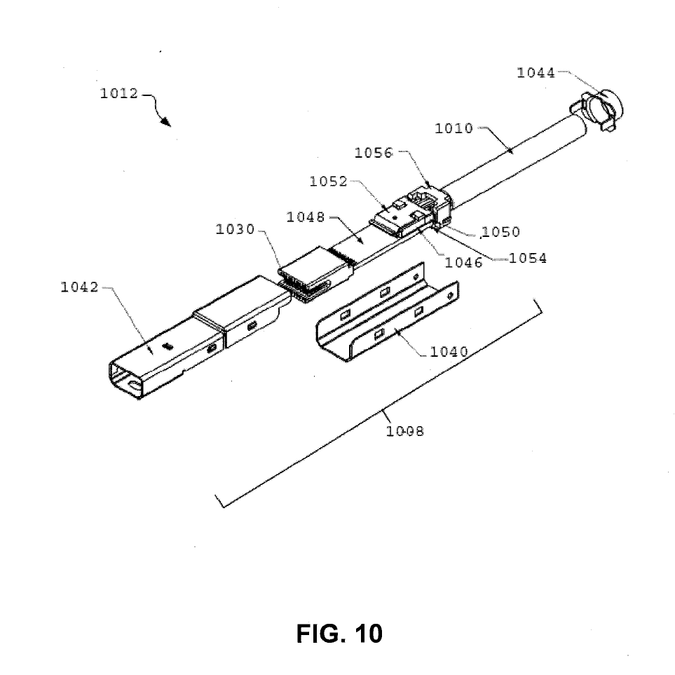

FIG. 10 is an exploded view of an embodiment of an optical cable assembly 1012 for use with cable 1010 that is configured in accordance with one of the embodiments describe above. The optical cable assembly 1012 may represent one example of an optical cable assembly having an active light engine. While the specific example illustrated is an mDP connector, it will be understood that other connector types can be equally constructed as described herein. Thus, optical communication through a standard connector can be implemented in an active way by fitting optical circuitry and components, or electro-optical circuitry and components, into the connector plug 1008.

The optical cable assembly 1012 may include one or more components similar to those of other embodiments of optical cable assemblies described herein. The connector plug 1008 of the optical cable assembly 1012 may include, for example, one or more of a plug housing 1030, a cable 1010, a plug cap 1044, a top shield 1040, and a bottom shield 1042. Within the top shield 1040 and the bottom shield 1042, the connector plug 1008 may include a lens 1046 for providing, at least in part, optical interfacing for the optical cable assembly 1012. In various embodiments, the lens 1046 comprises a lens body with one or more optical surfaces and one or more total-internal-reflection (TIR) surfaces. The lens 1046 may be configured to expand an optical beam on transmit to facilitate optical communication. In an expanded-beam optical interfacing approach, the lens 1046 may expand and collimate transmit signals, and focus receive signals. As understood by those of skill in the art, collimating may refer to making the photons of the light signal more parallel in reception.

The lens 1046 may be mounted on a substrate 1048 and constructed of any appropriate material, which may include plastic, glass, silicon, or other material or materials that can be shaped and that can provide optical focusing. In various embodiments, plastic lenses may provide convenience in cost, manufacturing, and durability. In various embodiments, suitable materials for the substrate 1048 may include, but are not limited to, a printed circuit board, a flex-board, or a lead frame. The printed circuit board may comprise any suitable material include a laminate (e. cladded with any suitable conductor (e.g., copper-clad laminate, etc.).

The connector plug 1008 may include a jumper 1050 configured to facilitate conveyance of optical signals between optical fibers (within the cable jacket of the cable 1010, shown in more detail later) and a light engine mounted on the substrate 1048. A latch 1052 may be configured to secure engagement between the jumper 1050 and the lens 1046. The jumper 1050 may be fixed to the optical fibers of the cable 1010 using glue or another suitable adhesive. In various embodiments, the jumper 1050 may be part of a jumper assembly including a fiber holder 1054 and a fiber holder cover 1056 for capturing and aligning the optical fibers.

The fiber holder may be configured to compress the optical fibers. In this manner, the fiber holder 1054 and the fiber holder cover 1056 may operate to constrain the motion of the optical fibers inside the connector plug 1008. By constraining the motion of the optical fibers, the fiber holder 1054 and the fiber holder cover 1056 may resist stress to the optical fibers due to movement of the cable 1010 (or relative movement of the connector plug 1008 and the cable 1010). By protecting the optical fibers from movement stress, impact to the integrity the optical fibers may be reduced relative to conventional optical cable solutions. In various embodiments, constraining the motion of the optical fibers may resist transference of motion of the cable 1010 to the jumper 1050, which may tend to reduce disruption to the optical signals. The two-piece design of the fiber holder 1054 and the fiber holder cover 1056 may tend to provide support to the bottom of the substrate 1048 and may help fix the end of the substrate 1048 within the other components (e.g., the top shield 1040 and bottom shield 1042) of the connector plug 1008.

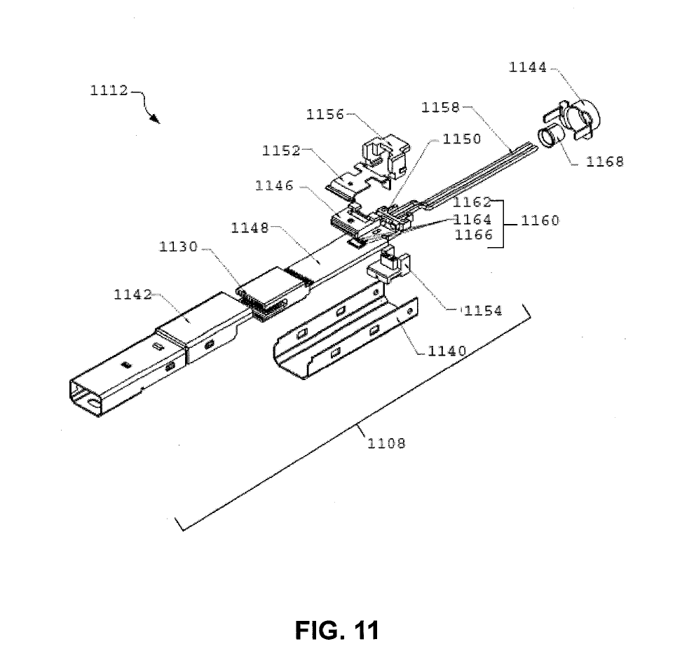

FIG. 11 is an exploded view of an embodiment of an optical cable assembly 1112 for use with cable 910 that is configured in accordance with one of the embodiments describe above. The optical cable assembly 1112 may represent one example of an optical cable assembly having an active light engine. While the specific example illustrated is an mDP connector, it will be understood that other connector types can be equally constructed as described herein. Thus, optical communication through a standard connector can be implemented in an active way by fitting optical circuitry and components, or electro-optical circuitry and components, into the connector plug 1108.

The optical cable assembly 1112 may include one or more components similar to those of other embodiments of optical cable assemblies described herein. The connector plug 1108 of the optical cable assembly 1112 may include, for example, one or more of a plug housing 1130, a plug cap 1144, a top shield 1140, a bottom shield 1142, a substrate 1148, a lens 1146, a latch 1152, a jumper 1150, a fiber holder 1154, a fiber holder cover 1156, and optical fibers 1158.

As in other embodiments described herein, the connector plug 1108 may include an active light engine 1160 configured to actively generate and/or receive, and process optical signals. The light engine 1160 may include a laser diode 1162 to generate optical signals, an optical IC 1164 to control optical interface, and a photodiode 1166 to receive optical signals. In various embodiments, the optical IC 1164 may be configured to control the laser diode 1162 and the photodiode 1166. In various embodiments, the optical IC 1164 may be configured to drive the laser diode 1162 and amplify optical signals from the photodiode 1166. In various embodiments, the laser diode 1162 comprises a VCSEL. Various components of the light engine 1160 may be mounted onto the substrate 1148. The light engine 1160 may be configured or programmed for a particular communication protocol, or may be configured or programmed for various different communication protocols. In various embodiments the light engine 1160 may include different light engines configured for different protocols.

In various embodiments, the lens 1146 may be configured to focus received light onto a receive component of the light engine 1160 (e.g., a photodiode 1166), and expand light from a transmit component of the light engine 1160 (e.g., a laser diode 1162). The connector plug 1108 may be configured to support one or multiple optical channels. For embodiments including multiple optical channels, the connector plug 1108 may include additional lenses for transmit and receive, and corresponding transmit and receive components of the light engine 1160.

In various embodiments, the photodiode 1166, or a component with a photodiode circuit may be considered an optical termination component in that the photodiode may be configured to convert optical signals to electrical signals. The laser diode 1162 may be configured to convert electrical signals to optical signals. The optical IC 1164 may be configured to drive the laser diode 1162 based on a signal to be transmitted optically, by driving the laser with appropriate voltages to generate an output to produce the optical signal. The optical IC 1164 may be configured to receive the electrical signals generated by the photodiode 1166 and process them for interpretation. In one embodiment, the optical IC 1164 may be configured to perform power management to turn off one or more optical components (e.g., laser diodes, photodiodes, etc.) when not in use.

As with various embodiments described herein, the jumper 1150 may be part of a jumper assembly including the fiber holder 1154 and the fiber holder cover 1156 for capturing and aligning the optical fibers 1158. As will be understood by those skilled in the art, an aspect of the jumper assembly as illustrated in FIG. 11 is that the lens 1146 and optical fibers 1158 may be installable after solder processing. Electrical components may be installed or attached to the substrate 1148 via solder, which may include a reflow process. While different processing technologies are known, one common method is for a pick-and-place machine or equivalent to adhere (e.g., through a paste or glue, such as a solder paste) components in place, and place a solder paste at the electrical connections. The entire substrate 1148 with all installed components may then be exposed to heat or infrared (IR) to melt the solder paste (which typically includes solder flux), which solders the component leads to the trace contacts on the substrate 1148 or creates solder joints. The process may involve heat that is damaging to plastic components. Thus, installing the optical fibers 1158 and/or other plastic components post-solder-processing may avoid damage to the optical fibers 1158 and/or other plastic components.

Another aspect of the jumper assembly as illustrated is the passive alignment of optical components. Rather than requiring shining a light through an optical fiber 1158 and ensuring (e.g., manually) the alignment of each component prior to setting the components (e.g., via glue), the engaging of the lens assembly 1146 with the jumper 1150, and secured by the latch 1152 may act to passively align various components of the connector plug 1108 due at least in part to the molded, flat surfaces of the lens 1146 and the jumper 1150.

In various embodiments, the optical cable assembly 1112 may include a plug cap 1144 and jacket support 1168 cooperatively configured to resist stress to the optical fibers 1158 from movement of the cable.

In a data center, optical cables in accordance with embodiments may be used to connect electronic devices including servers, routers, switches, hardware firewalls, computers configured for monitoring and/or control, and the like. In such an arrangement, some or all of the devices may be interconnected with cables embodied as described herein, and other types of interconnections may be employed in combination with cables in accordance with embodiments as described herein.

Various embodiments herein are described as including a particular feature, structure, or characteristic, but every aspect or embodiment may not necessarily include the particular feature, structure, or characteristic. Further, when a particular feature, structure, or characteristic is described in connection with an embodiment, it will be understood that such feature, structure, or characteristic may be included in connection with other embodiments, whether or not explicitly described. Thus, various changes and modifications may be made to this disclosure without departing from the scope or spirit of the inventive concept described herein. As such, the specification and drawings should be regarded as examples only, and the scope of the inventive concept to be determined solely by the appended claims.

What is claimed is:

1. A cable comprising:
a ribbon fiber comprising a plurality of optical fibers joined together and disposed within a conduit extending along a length of the cable;
the conduit having an inner diameter sufficiently larger than a largest cross-sectional length of the ribbon fiber to enable the ribbon fiber to rotate freely.

2. The cable of claim 1, further comprising a strength member, disposed within the conduit, wherein the inner diameter of the conduit is larger than a sum of the largest cross-sectional length of the ribbon fiber and a largest cross-sectional length of the strength member.

3. The cable of claim 1, further comprising:
a jacket, the jacket defining an outer surface of the cable.

4. The cable of claim 1, wherein the inner diameter is greater than 5% larger than the largest cross-sectional length of the ribbon fiber.

5. The cable of claim 1, further comprising:
at least one electrical conductor disposed within a jacket of the cable and separate from the conduit in which the ribbon fiber is disposed.

6. The cable of claim 5, wherein the at least one electrical conductor comprise a coaxial cable.

7. The cable of claim 5, wherein the at least one electrical conductor comprises two insulated conductors configured and arranged to transmit power and two corresponding insulated conductors configured and arranged to provide a ground.

8. The cable of claim 5, wherein the at least one electrical conductor comprises two insulated conductors and two coaxial cables.

9. The cable of claim 1, further comprising a termination device coupled to at least one end of the cable.

10. The cable of claim 9, wherein the termination device is configured in accordance with at least one communication protocol standard.

11. The cable of claim 9, wherein the termination device is configured to convert optical signals to electrical signals.

12. A cable comprising:
a ribbon fiber, disposed within a conduit extending along a length of the cable, the ribbon fiber comprising a plurality of optical fibers, the plurality of optical fibers arrayed such that the ribbon fiber has major and minor transverse axes; and
the conduit having an inner diameter larger than a largest cross-sectional length of the of the ribbon fiber such that, when the cable is subject to external forces, the ribbon fiber is able to rotate freely such that it bends along a direction perpendicular to its major transverse axis.

13. The cable of claim 12, further comprising:
an outer jacket;
a strength member, disposed within the conduit, wherein the inner diameter is greater than the largest cross-sectional length of the ribbon fiber plus a diameter of the strength member; and
at least one electrical conductor, disposed separate from the conduit.

14. The cable of claim 12, wherein the inner diameter is greater than 5% larger than the largest cross-sectional length of the ribbon fiber.

15. The cable of claim 12, further comprising:
at least one electrical conductor disposed within a jacket of the cable and separate from the conduit in which the ribbon fiber is disposed.

16. The cable of claim 15, wherein the at least one electrical conductor comprises two insulated conductors configured and arranged to transmit power and two corresponding insulated conductors configured and arranged to provide a ground.

17. The cable of claim 12, further comprising a termination device coupled to at least one end of the cable, the termination device being configured in accordance with at least one communication protocol standard.

18. The cable of claim 17, wherein the termination device is configured to convert optical signals into electrical signals.

19. A cable assembly comprising:
a cable including:
an outer jacket,
a ribbon fiber, disposed within a conduit extending along a length of the cable, the ribbon fiber comprising a plurality of optical fibers, the plurality of optical fibers arrayed such that the ribbon fiber has major and minor transverse axes,
the conduit having an inner diameter larger than a largest cross-sectional length of the of the ribbon fiber such that, when the cable is subject to external forces, the ribbon fiber is able to rotate freely such that it bends along a direction perpendicular to its major transverse axis, and
a strength member, disposed within the conduit, wherein the inner diameter is greater than the largest cross-sectional length of the ribbon fiber plus a diameter of the strength member; and
a termination device coupled to at least one end of the cable, the termination device being configured in accordance with at least one communication protocol standard.

20. The cable assembly of claim 19, wherein the cable includes at least one electrical conductor disposed separate from the conduit and the termination device is configured to convert optical signals into electrical signals.
